(19) United States
(12) Patent Application Publication
(10) Pub. No.: US 2008/0020260 A1
(43) Pub. Date: Jan. 24, 2008

(54) APPARATUS, SYSTEM, AND METHOD FOR MANIFOLDED INTEGRATION OF A HUMIDIFICATION CHAMBER FOR INPUT GAS FOR A PROTON EXCHANGE MEMBRANE FUEL CELL

(76) Inventors: Chris A. Brydon, Salt Lake City, UT (US); Ken Pearson, Shingle Springs, CA (US)

Correspondence Address: Kunzler & McKenzie, 8 EAST BROADWAY, SUITE 600, SALT LAKE CITY, UT, 84111, US

(21) Appl. No.: 11/828,265

(22) Filed: Jul. 25, 2007

Related U.S. Application Data
(63) Continuation-in-part of application No. 11/270,947, filed on Nov. 12, 2005.

(51) Int. Cl. H01M 8/04

(52) U.S. Cl. 429/39

(57) ABSTRACT

An apparatus, system, and method are disclosed for the manifolded integration of a humidification chamber for input gas for a fuel cell stack. An input gas chamber and water vapor chamber are integrated with a fuel cell stack. The input gas chamber has one wall, an input gas inlet that receives an input gas flow, and an input gas outlet in fluid communication with the fuel cell stack. The water vapor chamber has a wall, a water vapor inlet, and a water vapor outlet. The water vapor inlet receives a water vapor flow from the fuel cell stack. A water-selective membrane is disposed between the input gas chamber and the water vapor chamber. The water-selective membrane forms a common wall between the input gas chamber and the water vapor chamber. The water-selective membrane selectively diffuses water from the water vapor flow to the input gas flow.

### CROSS-REFERENCES TO RELATED APPLICATIONS

This application is a continuation-in-part of and claims priority to U.S. patent application Ser. No. 11/270,947 entitled “HYDROGEN GENERATOR CARTRIDGE” and filed on Nov. 12, 2005 for Shurtleff et al., which is incorporated herein by reference.

### BACKGROUND OF THE INVENTION

1. Field of the Invention

This invention relates to proton exchange membrane (PEM) fuel cells and more particularly relates to humidifying the input gas for PEM fuel cells.

2. Description of the Related Art

It is critical to operation of proton exchange membrane (PEM) fuel cells that the PEM remains hydrated. Partially dehydrated PEMs significantly decrease the power density of the fuel cells, which means that larger, and often more expensive fuel cells are required to obtain the same power density obtained by a well hydrated stack.

PEM fuel cells usually have a PEM, an anode, a cathode, and a catalyst. The anode, the negative post in a fuel cell, is positioned to one side of the catalyst and PEM, and the cathode, the positive post of a fuel cell, is positioned to the other side. A hydrogen flow is pumped through channels in the anode, and oxygen is pumped through channels in the cathode. The catalyst facilitates a reaction on the anode side causing the hydrogen gas to split into two H+ ions and two electrons. The electrons are conducted through the anode to the external circuit, and back from the external circuit to the cathode. The catalyst also facilitates a reaction on the cathode side causing the oxygen molecules in the air to split into two oxygen ions, each having a negative charge. This negative charge draws the H+ ions through the PEM, where two H+ ions bond with an oxygen ion and two electrons to form a water molecule.

Because fuel cells produce heat and water on their cathode or oxygen side, oxygen may gather water as it passes through the fuel cells. To increase the electrical power output of a PEM fuel cell, the flows of oxygen and hydrogen are increased, and the heat produced as a byproduct of the chemical reactions is also increased. Increased oxygen flow through the fuel cells combined with increased heat can quickly dehydrate PEMs in a fuel cell stack, as more water is removed by the oxygen flow. Partially dehydrated PEMs decrease the power density of the fuel cell stack because the resistance for the H+ ions passing through the PEMs is increased as moisture is removed from the fuel cells.

Solutions to this problem include limiting the electric power output of the fuel cells, or using larger fuel cells. Increasing the size of fuel cells limits the portability of the fuel cells, and increases the manufacturing and material costs. Limiting the electric power output of fuel cells also limits the fuel cells' use to low power applications.

### SUMMARY OF THE INVENTION

From the foregoing discussion, it should be apparent that a need exists for an apparatus, system, and method to humidify the proton exchange membranes of fuel cells. Beneficially, such an apparatus, system, and method would increase the electrical power output of proton exchange membrane fuel cells without increasing their size.

The present invention has been developed in response to the present state of the art, and in particular, in response to the problems and needs in the art that have not yet been fully solved by currently available proton exchange membrane fuel cell systems. Accordingly, the present invention has been developed to provide an apparatus, system, and method for humidifying an input gas for a proton exchange membrane fuel cell that overcomes many or all of the above-discussed shortcomings in the art.

The apparatus to humidify an input gas for a proton exchange membrane fuel cell stack is provided with a plurality of elements configured to functionally execute the necessary steps of humidifying an input gas. These elements in the described embodiments include an input gas chamber, a water vapor chamber, a water-selective membrane, a fuel cell stack, one or more structural layers of the fuel cell stack, a fuel cell stack input manifold, fuel cell stack plates, a hydrogen chamber, an O-ring, at least one fuel cell stack fastener, and a support member.

The input gas chamber, in one embodiment, is integrated with the fuel cell stack. The input gas chamber has at least one wall, an input gas inlet that receives an input gas flow, and an input gas outlet that is in fluid communication with the fuel cell stack. In a further embodiment, the input gas chamber is formed within a structural layer of the fuel cell stack, and it has an area footprint less than at least one fuel cell in the fuel cell stack. In another embodiment, the structural layer has one of a length and a width that is less than or equal to a corresponding length and width of one of the fuel cells in the fuel cell stack. In one embodiment, the input gas chamber minimizes a pressure drop between the input gas inlet and the input gas chamber. In addition, the apparatus includes an input gas path to the input gas chamber, the input gas path and a cross-sectional area of the input gas chamber configured to minimize a pressure drop between the input gas inlet and the input gas chamber.

In one embodiment, the input gas flow comprises oxygen gas. In another embodiment, the input gas flow is ambient air. In a further embodiment, the input gas flow comprises hydrogen gas. In another embodiment, the input gas chamber and the water vapor chamber are oriented so that liquid water from the water vapor flow collects on the water-selective membrane, in response to gravity.

The hydrogen chamber, in one embodiment, is integrated with the fuel cell stack. The hydrogen chamber has at least one wall, an input gas inlet that receives a hydrogen flow, and an input gas outlet that is in fluid communication with the fuel cell stack. In a further embodiment, the hydrogen chamber is disposed on an opposite side of the water-selective membrane as the water vapor chamber.

In one embodiment, the water vapor chamber is integrated with the fuel cell stack, and has at least one wall. The water vapor chamber has a water vapor inlet that receives a water vapor flow from the fuel cell and a water vapor outlet. In another embodiment, the water vapor chamber is formed within a structural layer of the fuel cell stack, and it has an area footprint less than at least one fuel cell in the fuel cell stack. In one embodiment, the input gas chamber and the water vapor chamber are formed within the same structural layer of the fuel cell stack, in another embodiment they are formed within separate structural layers of the fuel cell stack. In one embodiment, one of the chambers is formed within a fuel cell stack input manifold and the other chamber is formed within a fuel cell stack plate.

In a further embodiment, the water-selective membrane is disposed between the input gas chamber and the water vapor chamber, forming a common wall between them. The water-selective membrane selectively diffuses water from the water vapor flow to the input gas flow. In another embodiment, a rate of diffusion of water through the water-selective membrane is determined by a water concentration gradient across the water-selective membrane. In one embodiment, the water-selective membrane is substantially impermeable to hydrogen, nitrogen, oxygen, and metallic oxides.

In another embodiment, the O-ring is between the two structural layers in the fuel cell stack that comprise the input gas chamber and the water vapor chamber. The O-ring substantially circumscribes the input gas chamber and the water vapor chamber providing a seal between the two structural layers. In one embodiment, structural layers of the fuel cell stack assembly are coupled to the fuel cell stack by way of the at least one fuel cell stack fastener by way of compression.

In a further embodiment, the first support member is within the water vapor chamber. The first support member supports the water-selective membrane so that the water vapor chamber remains passable to the water vapor flow. In one embodiment, the input gas chamber and the water vapor chamber have serpentine shapes, and the first support member is a wall of the water vapor chamber. In another embodiment, the first support member is a rib in a central position between two opposite sides of the water vapor chamber. In one embodiment, the first support member and one or more additional support members are within the water vapor chamber according to a pattern that generates turbulence in the water vapor flow.

A system of the present invention is also presented to humidify an input gas for a proton exchange membrane fuel cell stack. The system may be embodied by a fuel cell stack, an air intake filter, one or more air pumps, an enclosure, and an air humidifier. In particular, the system, in one embodiment, includes a base manifold.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for humidifying input gas for a fuel cell in accordance with the present invention;

FIG. 2 is a schematic block diagram illustrating one embodiment of a bottom humidifier body in accordance with the present invention;

FIG. 3 is a schematic block diagram illustrating a further embodiment of a top humidifier body in accordance with the present invention; and

FIG. 4 is a schematic block diagram illustrating one embodiment of a base manifold in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

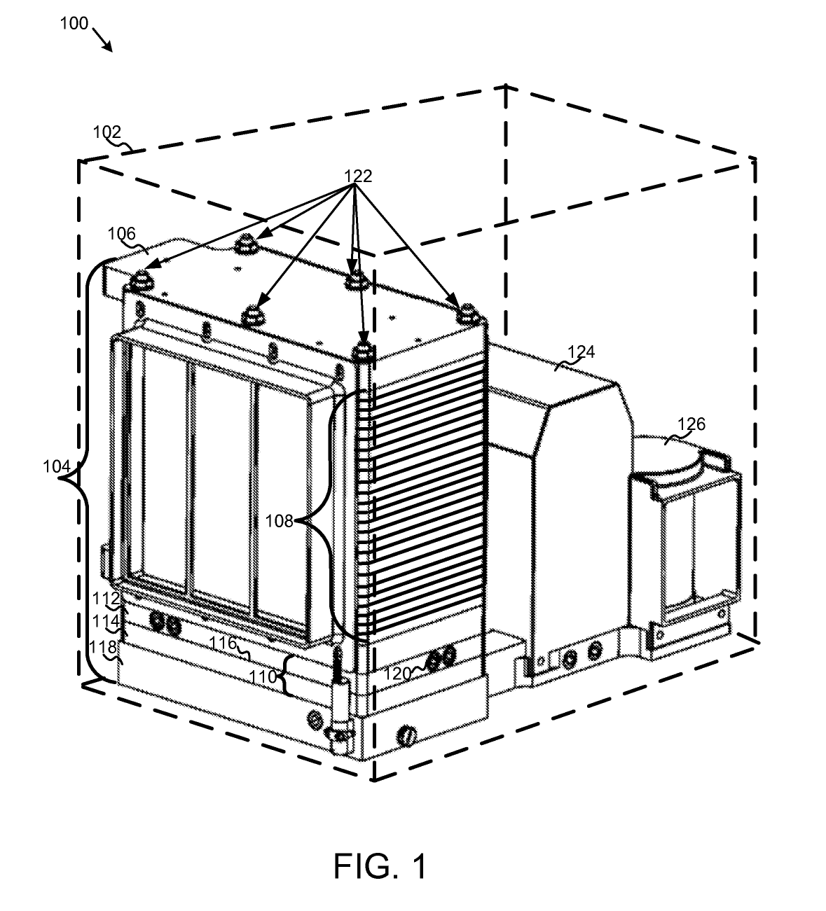

FIG. 1 depicts one embodiment of a system 100 for humidifying input gas for a proton exchange membrane (PEM) fuel cell stack. The system 100 includes an enclosure 102, a fuel cell stack assembly 104, one or more air pumps 124, and an air filter 126.

In one embodiment, the enclosure 102 is configured to encase and protect the system 100. The enclosure 102 may provide a space or volume constrained environment for the system 100. The enclosure 102 illustrates that a footprint that the fuel cell stack 104 and integrated humidifier 110 each take up no more than the same amount of area. Certain embodiments, may not employ an enclosure. In one embodiment, the enclosure 102 increases the portability or the safety of the system 100. In a further embodiment, the enclosure 102 dampens noise generated by the one or more air pumps 124. Alternatively, an enclosure encloses the air pumps 124 to further damped noise. The enclosure 102 may comprise a durable material such as metal, plastic, and the like. In one embodiment, the enclosure 102 is a lightweight material to increase the portability of the system 100. Because the enclosure 102 may have space or volume constraints, the fuel cell stack assembly 104, the one or more air pumps 124, and the air filter 126 may be limited to certain areas, volumes, or orientations.

The enclosure 102 may also have predefined areas for the fuel cell stack assembly 104, the one or more air pumps 124, the air filter 126, and other components of the system 100. The predefined areas may be allocated by design constraints, optimization for portability, efficiency, ease of manufacture, and the like. The predefined areas may also comprise walls, fasteners, holes, markings, or the like to facilitate the installation and use of system components within the enclosure 102.

In one embodiment, the fuel cell stack assembly 104 comprises a fastening structural layer 106, a fuel cell stack 108, a humidifier 110, an input structural layer 118, one or more plugs 120, and one or more fasteners 122. In general, the fuel cell stack assembly 104 creates electric power from two input gas flows, a hydrogen flow and an oxygen flow, as is known in the art. The fuel cell stack assembly 104 may receive the hydrogen flow from a hydrogen source, such as a pressurized hydrogen tank, a hydrogen generator that generates hydrogen from a hydrogen source such as water, chemical hydrides, and the like, or from another hydrogen source. The fuel cell stack assembly 104 may receive the oxygen flow from an oxygen source, such as a pressurized oxygen tank, a chemical reaction, ambient air, and the like. The fuel cell stack assembly 104 integrates the humidifier 110 with the fuel cell stack 108, and may be in other orientations, orders, and configurations than the vertical orientation illustrated in FIG. 1. In one embodiment, the oxygen flow and the hydrogen flow pass through internal passages or manifolds within the fuel cell stack assembly 104. The internal passages and/or manifolds may pass through the layers of the fuel cell stack assembly 104. The manifolded integration of the humidifier 110 with the fuel cell stack 108 increases reliability and consistency of the system 100, ease manufacturing and assembly, optimize available space, minimize fuel cell assembly size, and eliminate tubing or other parts.

In one embodiment, the fastening structural layer 106 is integrated with the fuel cell stack assembly 104, and disposed on one end of the fuel stack assembly 104. The fastening structural layer 106 may comprise manifolds or passages that provide fluid communication for the hydrogen flow and the oxygen flow. In a further embodiment, the fastening structural layer may comprise a hydrogen outlet or an oxygen outlet. The fastening structural layer 106 may assist the fasteners 122 in securing the members of the fuel cell stack assembly 104 by compression, or by another securing method. In a further embodiment, the fastening structural layer 106 may be a plate in the fuel cell stack 108, comprising a cathode plate, or an anode plate.

In one embodiment, the fuel cell stack 108 comprises one or more fuel cells in a stack configuration. In another embodiment, each of the fuel cells in the fuel cell stack 108 have a proton exchange membrane (PEM), an anode, a cathode, and a catalyst. A microlayer of the catalyst may be coated onto carbon paper, cloth, or another gas diffusion layer, and positioned adjacent to the PEM, on both sides. The anode, the negative post in a fuel cell, is positioned to one side of the catalyst and PEM, and the cathode, the positive post of a fuel cell, is positioned to the other side. The hydrogen flow is pumped or forced through channels in the anode, and oxygen, in the form of ambient air or otherwise, is pumped or forced through channels in the cathode. The catalyst facilitates a reaction on the anode side causing the hydrogen gas to split into two H+ ions and two electrons. The electrons are conducted through the anode to the external circuit, and back from the external circuit to the cathode. The catalyst also facilitates a reaction on the cathode side causing the oxygen molecules in the air to split into two oxygen ions, each having a negative charge. This negative charge draws the H+ ions through the PEM, where two H+ ions bond with an oxygen ion and two electrons to form a water molecule.

The fuel cell plates in the fuel cell stack 108 may have channels, chambers, passages or the like to guide the hydrogen flow and the oxygen flow from fuel cell to fuel cell through the fuel cell stack 108. Because the fuel cell stack 108 produces heat and water on the cathode or oxygen side, the oxygen flow may gather water as it passes from fuel cell to fuel cell. In one embodiment, the oxygen flow that exits the fuel cell stack 108 comprises a saturated water vapor flow. Under high loads, an increased air flow and an increase in heat produced may partially dehydrate the PEMs, as more water is removed by the oxygen flow.

To maintain PEM hydration, the fuel cell stack assembly 104 may hydrate one or more input gas flows using the humidifier 110. The humidifier 110 may comprise a top humidifier body 110, a bottom humidifier body 112, and a water-selective membrane 116. Adding moisture to one or more of the input gasses keeps the PEMs in each of the fuel cells 108 moist. Partially dehydrated PEMs decrease the power density of the fuel cell stack 108. Moisture decreases the resistance for the H+ ions passing through the PEMs, increasing the power density of the fuel cell stack 108. In one embodiment, the moist water vapor flow exiting the fuel cell stack 108 passes one side of the water-selective membrane 116 within the humidifier 110 before exiting the fuel cell stack assembly 104, while a dry input gas flow passes the other side of the water-selective membrane 116 before the input gas flow enters the fuel cell stack 108. The water-selective membrane 116 selectively draws water from the wet water vapor side of the water-selective membrane 116 to the dry input gas side, humidifying the input gas before it enters the fuel cell stack 108. In a further embodiment, the water vapor flow has a higher temperature than the input gas flow, and the water vapor flow transfers heat to the input gas flow to increase the temperature of the input gas flow, by convection and conduction. Increasing the temperature of the input gas flow also increases the amount of water that can be held and carried by the input gas flow.

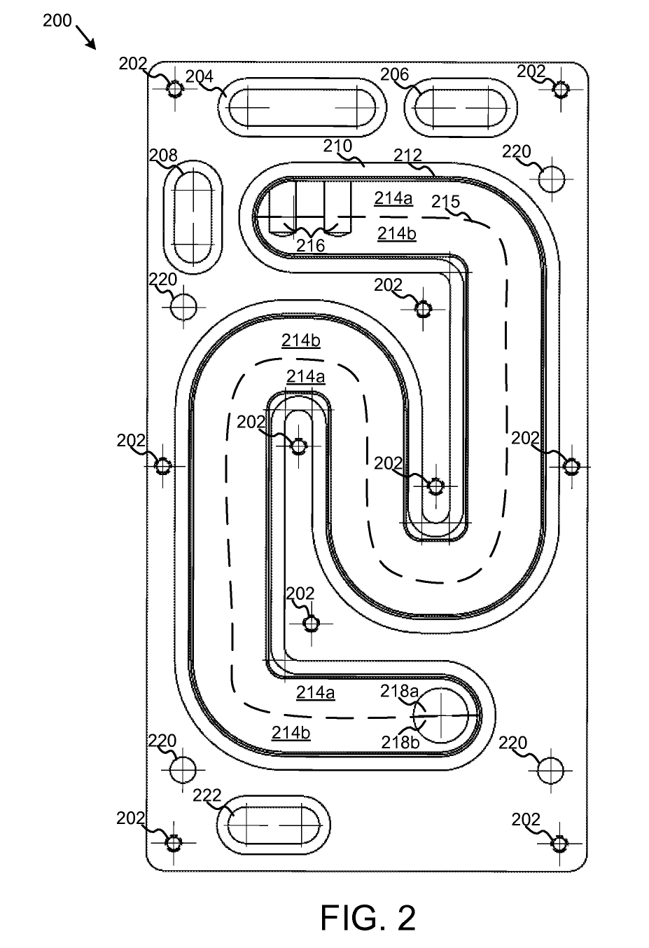

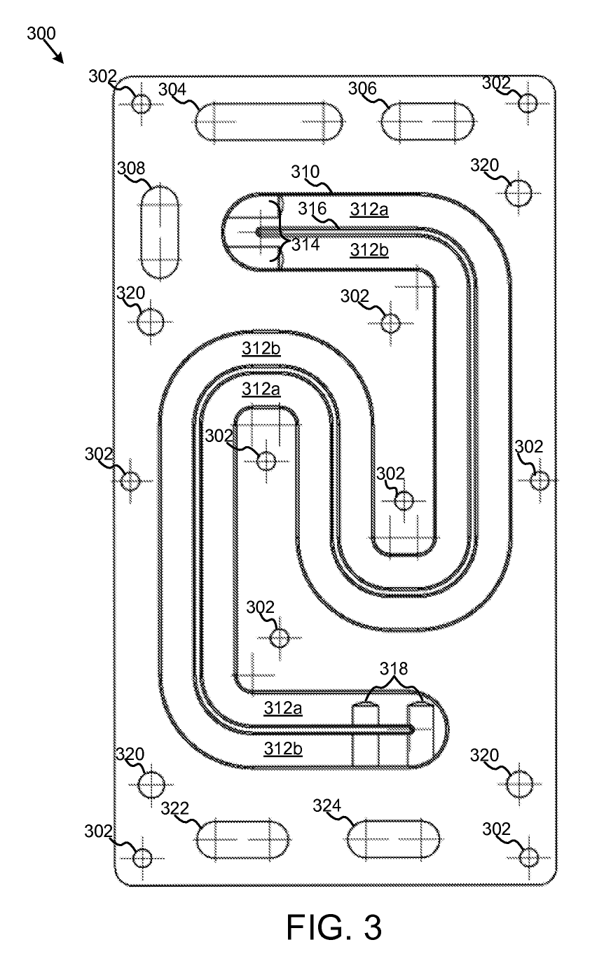

In one embodiment, the humidifier 110 is integrated with the fuel cell stack assembly 104. The humidifier 110 may comprise two humidifier bodies, the top humidifier body 112 and the bottom humidifier body 114, or may comprise a single humidifier body. Separating the humidifier 110 into two separate humidifier bodies may simplify manufacturing, assembly, or repair of the humidifier 110. Example embodiments of the top humidifier body 112 and the bottom humidifier body 114 are discussed in greater detail with regards to FIG. 2 and FIG. 3.

In one embodiment, the humidifier 110 comprises an input gas chamber. The input gas chamber guides the input gas flow across the water selective membrane 116 to the fuel cell stack 108. The input gas chamber is in fluid communication with one or more tubes, manifolds passages, or the like. The input gas chamber may be formed within the top humidifier body 112, the bottom humidifier body 114, or may be formed together with the water vapor chamber within a single humidifier body. The input gas chamber may comprise at least one wall, an input gas inlet, and an input gas outlet. The input gas inlet receives an input gas flow. The input gas inlet may receive the input gas flow from the input structural layer 118. The input gas flow may be a flow from a pump, such as the one or more air pumps 124, a flow from an input gas storage that stores the input gas under pressure, or a flow from an input gas generation system. The input gas outlet is in fluid communication with the fuel cell stack 108, such that the humidified input gas from the humidifier 110 enters the fuel cell stack 108 to generate electrical power and to hydrate the PEMs.

In a further embodiment, the humidifier 110 comprises multiple input gas chambers, such as an oxygen chamber and a hydrogen chamber. As with the input gas chamber described above, the oxygen chamber and the hydrogen chamber may each share a common wall with the water vapor chamber. The oxygen chamber and the hydrogen chamber may be substantially parallel, adjacent, or otherwise disposed within the humidifier 110. The oxygen chamber and the hydrogen chamber may be formed within the same humidifier body, or in separate bodies. The oxygen chamber and the hydrogen chamber may comprise separate sub-chambers in a single input gas chamber, such that the oxygen flow and the hydrogen flow are substantially separated from each other. In this manner, the oxygen chamber and the hydrogen chamber humidify both an oxygen flow and a hydrogen flow simultaneously after receiving the flows from two or more sources. The oxygen flow and the hydrogen flow may enter the oxygen chamber and the hydrogen chamber from the structural layer 118.

In one embodiment, the humidifier 110 comprises a water vapor chamber. The water vapor chamber guides the water vapor flow across an opposite side of the water-selective membrane 116 as the input gas flow. The water vapor chamber is in fluid communication with a water vapor source. In one embodiment, the water vapor source is an output stream from the fuel cell stack 108. The water vapor chamber may be formed within the top humidifier body 112, the bottom humidifier body 114, or may be formed within a single body with the input gas chamber. The water vapor chamber may comprise at least one wall, a water vapor inlet, and a water vapor outlet. The water vapor inlet receives a water vapor flow. The water vapor inlet may receive the water vapor flow from an outlet of the fuel cell stack 108. The water vapor flow may be the moist output air from the fuel cell stack 108. The water vapor inlet may interface with a channel, passage, or manifold in the fuel cell stack 108. The water vapor outlet may send the excess water vapor flow to a condenser or other device to remove additional water from the water vapor flow, or may vent or discard the excess water vapor flow.

In one embodiment, the water vapor flow in the water vapor chamber is at a lower gas pressure than the input gas flow in the input gas chamber. In one embodiment, the water vapor flow has a lower gas pressure than the input oxygen flow because the water vapor flow is the product of the input oxygen flow passing through the fuel cell stack. The lower gas pressure of the water vapor flow ensures that proper flow direction is maintained through the fuel cell stack. The pressure differential may cause the water-selective membrane 116 to collapse into the water-vapor chamber. The water vapor chamber may comprise one or more support members to support the water-selective membrane 116 such that the water vapor chamber remains passable to the water vapor flow, even under a pressure differential. The one or more support members may be one or more chamber walls of the water vapor chamber or the input gas chamber. The water vapor chamber and the input gas chamber may be in a substantially serpentine configuration such that the chamber walls comprise support members for the water-selective membrane 116.

In another embodiment, the one or more support members are pillars, posts, internal walls, ribs, screens, wires, mesh, or other structures within the water vapor chamber, and may be in a predefined pattern. The water vapor chamber may comprise a rib or other type of support member disposed centrally between the walls of the water vapor chamber, the rib running substantially the entire length of the water vapor chamber. In one embodiment, the one or more support members generate turbulence in the water vapor flow. The turbulence may mix the water vapor flow such that the concentration of water vapor is substantially consistent in the water vapor chamber. In another embodiment, the one or more support members also generate turbulence in the input gas chamber, mixing the input gas flow such that the input gas flow is substantially evenly hydrated. In a further embodiment, the input gas chamber has a lower gas pressure than the water vapor chamber, and the input gas chamber comprises one or more support members. This may occur for example if the input gas flow is a hydrogen flow that will enter a fuel cell stack. In addition, this may occur if the water vapor flow originates from a source other than an outlet of a fuel cell stack, such as for example a pump, a tank, or another pressurized water source.

In one embodiment, the top humidifier body 112 may be a structural layer of the fuel cell stack assembly 104. The top humidifier body 112 may be an independent structural layer of the fuel cell stack assembly 104, or the top humidifier body 112 may be integrated with another structural layer, including a fuel cell cathode or anode plate, the input structural layer 118, the fastening structural layer 106, or another structural layer in the fuel cell stack assembly 104. The top humidifier body 112 may comprise a polymer, a metal, a composite, a fiberglass, or another material or combination of materials that is configured to withstand heat generated by the fuel cell stack 108 and contact with moisture from the humidification process.

In one embodiment, the bottom humidifier body 114 may be a structural layer of the fuel cell stack assembly 104 disposed opposite the top humidifier body 112. The bottom humidifier body 112 may be an independent structural layer of the fuel cell stack assembly 104, or the bottom humidifier body 112 may be integrated with another structural layer, including a fuel cell cathode or anode plate, the input structural layer 118, the fastening structural layer 106, or another structural layer in the fuel cell stack assembly 104 that is opposite the top humidifier body 112. The bottom humidifier body 112 may comprise a polymer, a metal, a composite, a fiberglass, or another material or combination of materials that is configured to withstand heat generated by the fuel cell stack 108 and contact with moisture from the humidification process. In one embodiment, the top humidifier body 112 and the bottom humidifier body 114 comprise the same material. In a further embodiment, the top humidifier body 112 and the bottom humidifier body 114 each comprise a different material, because they are integrated into separate structural layers in the fuel cell stack assembly 104, such as a metal fuel cell plate and a plastic manifold.

In one embodiment, the top humidifier body 112 and the bottom humidifier body 114 are substantially sealed such that the gas flows are substantially confined to their respective chambers, inlets, and outlets, and such that gasses and other external influences are prevented from entering the input gas chamber and the water vapor chamber. In a further embodiment, an O-ring, gasket, or other sealing means is disposed between the top humidifier body 112 and the bottom humidifier body 114. The O-ring, gasket, or other sealing means may substantially circumscribe the input gas chamber and the water vapor chamber, providing a seal.

In one embodiment, the water vapor chamber is formed within the top humidifier body 112, and the input gas chamber is formed within the bottom humidifier body 114 such that liquid water from the water vapor flow collects on the water-selective membrane 116 in response to gravity. This allows for optimal water transfer across the water-selective membrane 116. In a further embodiment, the orientation, position, and area of the top humidifier body 112 and the bottom humidifier body 114 are configured to substantially maintain the area footprint of the fuel cell stack assembly 104. In one embodiment, the humidifier 110 has an area footprint that fits within a fuel cell stack area in the enclosure 102. The area footprint of the humidifier 110 may be less than or equal to the area footprint of the fuel cells in the fuel cell stack 108. In one embodiment, the humidifier 110 is positioned in a vertical orientation parallel to the fuel cell stack 108 or in another orientation that better fits within the enclosure 102 or within another volume constrained environment.

In one embodiment, the water-selective membrane 116 is designed to allow substantially only water molecules to pass through the water-selective membrane 116. The water-selective membrane 116 is, in one embodiment, a thin, pliable, nonporous translucent plastic. The plastic may be a durable synthetic polymer with a high tensile strength (about 23 to 32 MPa) that is capable of maintaining its structural integrity in temperatures up to about 190 degrees C.

In certain embodiments, the water-selective membrane 116 is formed into a sheet. The water-selective membrane 116 may comprise a variety of materials. Preferably, the materials are polymers. One representative example of a material suitable for use as a water-selective membrane 116 in the present invention is Nafion® available from E. I. DuPont of Wilmington, Del. Specifically, the water-selective membrane 116 may be a perfluorosulfonic acid/PTFE (polytetrafluoroethlene) copolymer in the acid (H⁺) form.

Preferably, the water-selective membrane 116 is highly selective and permeable to water. The water-selective membrane 116 is an ionomer that is highly ion-conductive and includes sulfonic acid groups. The sulfonic acid groups in the polymer chains that comprise the water-selective membrane 116 attract water molecules. The water molecules are passed along one or more cross-linked polymer chains of the water-selective membrane 116 and exit the water-selective membrane 116 on the opposite side.

The water-selective membrane 116 transports water through the membrane by diffusion. The diffusion of water through the water-selective membrane 116 is naturally controlled by a water concentration gradient across the water-selective membrane 116. The concentration gradient ensures that water is diffused at a substantially constant rate if the concentration gradient is constant.

The thermodynamic driving force acting on the water is the difference in the water's chemical potential across the water-selective membrane 116. The flux of water through the water-selective membrane 116 can be calculated as follows:
dM/dt=P*Δc/d (1)

dM/dt is the mass flux, P is the permeability coefficient of the water-selective membrane 116 for water, Δc is the concentration gradient, and d is the thickness of the water-selective membrane 116.

Equation 1 illustrates that the water flux is affected by the thickness of the water-selective membrane 116. The concentration gradient, Δc, of water across the water-selective membrane 116 will vary based on the humidity of the water vapor flow and the humidity of the input gas. If the water vapor flow is saturated, and liquid water has collected on the water-selective membrane 116, the concentration gradient Δc may be substantially 100% if the input gas is substantially dry. In other situations or in humid environments, the input gas may already be humid, and the concentration gradient Δc may be lower. The permeability (P) of the water-selective membrane 116 is affected by several factors including the type of polymer used in the water-selective membrane 116. The water-selective membrane 116 should be permeable to H₂O, but impermeable to the larger alkali and alkali-earth by-products, hydrogen, nitrogen, oxygen, and particles.

The solution-diffusion model, originally developed by Lonsdale, Merten, and Riley, closely models the transport of water through the water-selective membrane 116. The permeability depends on the diffusion of water in the water-selective membrane 116, which is closely related to the type of branching chains on the polymer backbone.

In one embodiment, the input structural layer 118 comprises a fuel cell stack input manifold that provides inputs for the oxygen flow and the hydrogen flow and guides the input gas flows to the humidifier 110. In one embodiment, the humidifier 110 is configured to humidify one input gas and to pass the other input gas through un-humidified from the input structural layer 118 to the fuel cell stack 108. In a further embodiment, the humidifier 110 is configured to humidify both the oxygen flow and the hydrogen flow simultaneously after receiving the flows from the input structural layer 118. The input structural layer 118 may also comprise passages for one or more exit gasses, such as the excess water vapor flow, or a hydrogen purge flow. The input structural layer 118 may comprise a polymer, a metal, or another material capable of transporting the input gasses through internal passages or chambers.

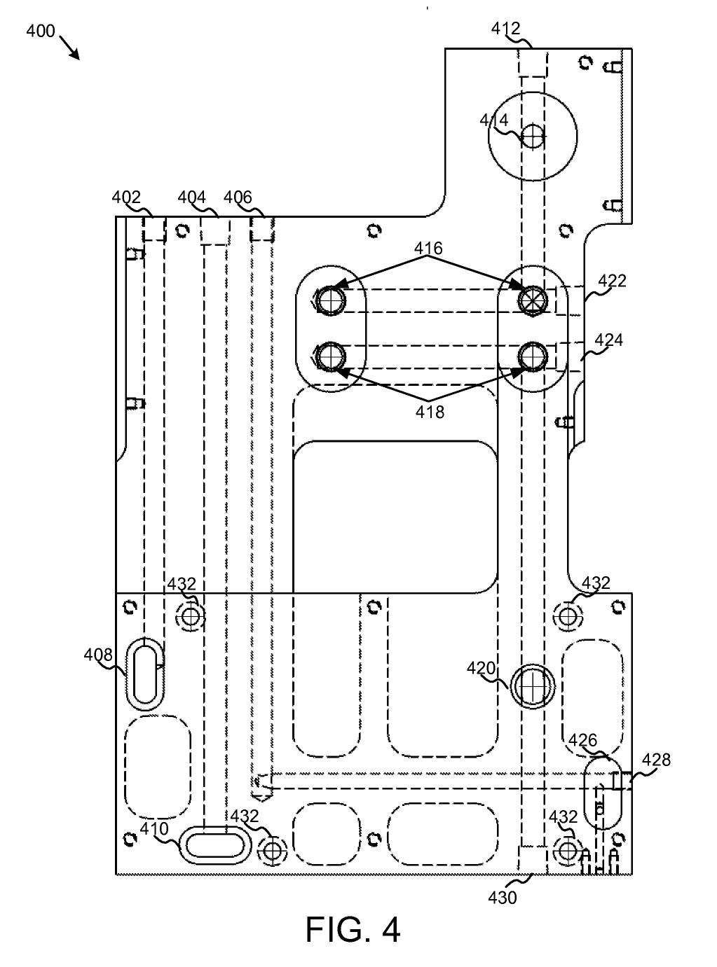

In one embodiment, the input structural layer 118 comprises a base manifold for the system 100. One example of a base manifold that may be substantially similar to the input structural layer 118 is discussed in greater detail with regards to FIG. 4. In one embodiment, the input structural layer 118 provides fluid communication for the oxygen flow from the air intake filter 126, to the one or more air pumps 124, to the fuel cell stack assembly 104. The input structural layer 118 may also provide structural support to the air intake filter 126, the one or more air pumps 124, and the fuel cell stack assembly 104, and may comprise one or more locking, fastening, or securing interfaces.

In one embodiment, the input structural layer 118 and the humidifier 110 may comprise one or more plugs 120. The manufacturing process of the input structural layer 118 and of the humidifier 110 may use cross-drill porting or other methods that leave extra passages or holes in the input structural layer 118 or in the humidifier 110. In one embodiment, the one or more plugs 120 seal the extra holes, such that the gas flows in the input structural layer 118 and the humidifier 110 cannot exit the system 100 through the extra holes.

In one embodiment, the one or more fasteners 122 secure the layers of the fuel cell stack assembly 104. The one or more fasteners 122 may be bolts, screws, or rods that run through the length of the fuel cell stack assembly 104, securing the layers using compression. The one or more fasteners 122 may also comprise nuts, pins, or other securing means to secure the bolts or rods. Alternatively, the one or more fasteners 122 may comprise one or more bands, ties, encasings, adhesives, hooks, plugs, locks, or other fastening elements that secure the layers of the fuel cell stack assembly 104, integrating the humidifier 110 with the fuel cell stack 108.

In one embodiment, one or more air filters 126 are configured to filter particles or other contaminants from an oxygen flow for use by the fuel cell stack assembly 104. In one embodiment, one or more air pumps 124 draw an oxygen flow into the system 100 through the air filters 126. The oxygen flow may comprise ambient air. The air pumps 124 may be diaphragm pumps, or other types of air pumps capable of maintaining an air pressure to match the hydrogen pressure in the fuel cell stack 108, for a maximum power density in the fuel cell stack 108. In one embodiment, the air pumps 124 are configured to increase or decrease the oxygen flow in response to a determined electrical load on the system 100. Varying the oxygen or air flow as a function of the electrical load reduces parasitic power losses and improves system performance at power levels below the maximum. In one embodiment, the one or more air pumps 124 have multiple pumping capabilities configured to optimize the amount of oxygen delivered to the fuel cell stack 108. For example, a smaller capacity air pump 124 may be activated during a low power demand state, a larger capacity air pump 124 may be activated during a medium power demand state, and both the smaller and the larger capacity air pumps 124 may be activated during a high power demand state. In one embodiment, the variable air flow provides a humidity control, transporting more water out of the fuel cell stack 108 at higher air flows than at lower air flows. Maintaining a substantially minimal air flow for a desired power demand may also minimize the dehydration of PEMs in the fuel cell stack 108.

Advantageously, the integration of the input gas chamber and water vapor chamber with the fuel cell stack 108 and input structural layer 118 minimizes the pressure drop from the input gas inlet, because of the relationship of sizes between the input gas inlet and the input gas chamber. The manifolded integration of the humidifier 110 decreases the input gas path length from the air pumps 124 to the fuel cell stack 108 by decreasing the amount of tubing and the like. The path length affects the pressure drop linearly. In preferred embodiments, the input gas path from the air pumps to the fuel cell stack 108 includes gentle curved turns to minimize flow friction.

The manifolded integration of the humidifier 110 also provides for greater cross-sectional area of the input gas chamber in comparison to cross-sectional areas available using tubing or the like. The cross-sectional area also affects the pressure drop linearly. A lower pressure drop in the input gas chamber requires less pressure from the air pumps 124 to maintain a target gas pressure at the fuel cell stack 108. Lower pressure requirements from the air pumps 124 cause the air pumps 124 to draw less electricity from a battery and/or a fuel cell stack assembly 104. In addition, smaller, less expensive, and less powerful air pumps 124 can be used. These smaller air pumps 124 reduce the parasitic losses in the system 100, because a lower amount of electric power is required to power the air pumps 124. This increases the efficiency of the system 100, and reduces the balance of plant consumption.

In one embodiment, the air pumps 124 comprise an air pump rated at about 10 to 14 volts direct current (DC), and draw a maximum of about 275 mA of current. The air pumps 125 may comprise an iron rotor ball bearing motor and a neoprene, Ethylenepropylene-diene monomer (EPDM), or Viton diaphragm. In one embodiment, the air pumps 125 provide a flow rate of about 10 to 12 liters per minute (LPM) under normal external pressures, 0 pound-force per square inch gauge (psig), and provide a decreasing flow rate under increased external pressures, providing substantially 0 LPM at external pressures greater than about 12 psig.

FIG. 2 illustrates one embodiment of a bottom humidifier body 200. The bottom humidifier body 200 may be substantially similar to the bottom humidifier body 114 of FIG. 1. In one embodiment, the bottom humidifier body 200 is secured to a top humidifier body by one or more humidifier fasteners 202. The humidifier fasteners 202 may be screws, bolts, pins, or other fasteners that secure the bottom humidifier body 200 to the top humidifier body. The humidifier fasteners 202, in one embodiment, also secure a water-selective membrane between the bottom humidifier body 200 and the top humidifier body.

In one embodiment, the bottom humidifier body 200 comprises an input gas outlet 204. The input gas outlet 204 may be an oxygen or air outlet, or a hydrogen outlet. The input gas outlet 204 is in fluid communication with a fuel cell stack input gas inlet. The input gas outlet 204 may interface with a passage in the top humidifier body such that humidified input gas from the bottom humidifier body 200 passes through the top humidifier body to the fuel cell stack input gas inlet for use by the fuel cell stack. In an alternative embodiment, the input gas outlet 204 comprises an oxygen outlet and a hydrogen outlet that are separated from each other such that humidified oxygen and humidified hydrogen are in fluid communication with separate fuel cell stack input gas inlets.

In one embodiment, the bottom humidifier body 200 comprises an input gas bypass passage 206 that is in fluid communication with a separate fuel cell stack input gas inlet or with another humidifier. The input gas bypass passage 206 allows a second input gas that is not humidified by the bottom humidifier body 200 to pass through or bypass the bottom humidifier body 200 and pass to a second humidifier or to the fuel cell stack un-humidified. For example, if the bottom humidifier body 200 humidifies an oxygen flow, a hydrogen flow may pass through the input gas bypass passage 206 to a hydrogen humidifier or to the fuel cell stack. In one embodiment, the bottom humidifier body 200 further comprises a water vapor outlet passage 208. The water vapor outlet passage 208 allows an excess water vapor flow from the top humidifier body to pass through the bottom humidifier body 200 to a manifold, a vent, a condenser, or elsewhere.

In one embodiment, the bottom humidifier body 200 comprises a sealing interface 210. The sealing interface 210 may be configured to seat an O-ring, gasket, or other sealing means. The sealing interface 210 may be an indentation or other space circumscribing an input gas chamber 214 that is configured to receive an O-ring, gasket, or other sealing means. In one embodiment, the O-ring, gasket, or other means assists in securing the water-selective membrane between the bottom humidifier body 200 and the top humidifier body. In a further embodiment, each of the inlets, outlets, chambers, and passages 204, 206, 208, 214, 220, 222 in the bottom humidifier body comprise a sealing interface substantially similar to the sealing interface 210.

In one embodiment, the bottom humidifier body 200 comprises an input gas chamber 214 with at least one wall 212. The input gas chamber 214 may be substantially similar to the input gas chamber described above with regards to FIG. 1. In one embodiment, the input gas chamber 214 is substantially serpentine, such that the wall 212 supports the water-selective membrane and the serpentine curves in the wall 212 provide turbulence in the input gas flow. The turbulence provides more consistent humidification. The at least one wall 212 may comprise a single curved wall, or multiple walls in a rectangular, triangular, or other multiple-wall chamber configuration.

In one embodiment, the input gas chamber 214 comprises an oxygen chamber 214a and a hydrogen chamber 214b. The oxygen chamber 214a may be separated from the hydrogen chamber 214b by a divider 215. The divider 215 may comprise a wall, rib, seal, or other barrier that substantially separates the oxygen chamber 214a from the hydrogen chamber 214b, such that the oxygen and the hydrogen have separate paths and do not mix. The divider 215 may be attached or otherwise connected to the water-selective membrane.

The input gas chamber 214 may also comprise one or more outlet passages 216 connecting the input gas chamber 214 to the input gas outlet 204. The one or more outlet passages 216 provide fluid communication between the input gas chamber 214 and the input gas outlet 204. In one embodiment, the outlet passages 216 are cross-drill ported during manufacturing. In a further embodiment, the one or more outlet passages 216 comprise an oxygen outlet and a hydrogen outlet, the oxygen outlet in fluid communication with the oxygen cavity 214a and the hydrogen outlet in fluid communication with the hydrogen cavity 214b. Each of the outlet passages may be in fluid communication with separate input gas outlet 204, as described above.

In one embodiment, the input gas chamber 214 comprises an input gas inlet 218 that receives the input gas flow. The input gas inlet is in fluid communication with an input gas source, which may be one or more pumps, pressurized input gas storage, or an input gas generation system. The input gas inlet 218 may receive the input gas flow from a manifold, passage, tubing, a base manifold, or other input gas guide. In another embodiment, the input gas inlet 218 comprises an oxygen inlet 218a and a hydrogen inlet 218b that are substantially separated from each other.

In one embodiment, the bottom humidifier body 200 comprises one or more fuel cell stack assembly fasteners 220. The one or more fuel cell stack assembly fasteners 220 may be substantially similar to the fasteners 122 described above with regards to FIG. 1. The fuel cell stack assembly fasteners 220 secure the bottom humidifier body 200 to a fuel cell stack assembly and integrate the bottom humidifier body 200 with the fuel cell stack.

In one embodiment, the bottom humidifier body 200 comprises a fuel cell hydrogen outlet passage 222. The fuel cell hydrogen outlet passage 222 may be connected to a hydrogen purge valve or other hydrogen outlet in the fuel cell stack. The hydrogen purge valve may vent hydrogen from the fuel cell stack when pressures reach unsafe levels, or routinely to keep the fuel cells stack in good condition by removing accumulated liquid water and impurities from the fuel cell stack, improving performance, and preventing corrosion of the catalyst. The fuel cell hydrogen outlet passage 222 allows an purged hydrogen flow from the fuel cell stack to pass through the bottom humidifier body 200 to a manifold, a vent, a condenser, or elsewhere.

FIG. 3 illustrates one embodiment of a top humidifier body 300. The top humidifier body 300 may be substantially similar to the top humidifier body 112 of FIG. 1. In one embodiment, the top humidifier body 200 is secured to a bottom humidifier body, such as the bottom humidifier body 200 of FIG. 2, by one or more humidifier fasteners 302. The humidifier fasteners 302 may be screws, bolts, pins, or other fasteners that secure the top humidifier body 300 to the bottom humidifier body. The humidifier fasteners 302, in one embodiment, also secure a water-selective membrane between the top humidifier body 200 and the bottom humidifier body.

In one embodiment, the top humidifier body 300 comprises an input gas passage 304. The input gas passage 304 may be an oxygen or air passage, or a hydrogen passage. The input gas passage 304 is in fluid communication with a fuel cell stack input gas inlet. The input gas passage 304 may interface with an input gas outlet in the bottom humidifier body such that humidified input gas from the bottom humidifier body passes through the top humidifier body 300 to the fuel cell stack input gas inlet for use by the fuel cell stack.

In one embodiment, the top humidifier body 300 comprises an input gas bypass passage 306 that is in fluid communication with a separate fuel cell stack input gas inlet or with another humidifier. The input gas bypass passage 306 allows a second input gas that is not humidified by the bottom humidifier body to pass through or bypass the top humidifier body 300 and pass to a second humidifier or to the fuel cell stack un-humidified.

In one embodiment, the top humidifier body 300 further comprises a water vapor chamber 312 and a water vapor outlet 308. The water vapor outlet 308 allows an excess water vapor flow from the water vapor chamber 312 to exit the top humidifier body 300 to a bottom humidifier body water vapor outlet passage, and then to a manifold, a vent, a condenser, or elsewhere.

In one embodiment, the top humidifier body 300 comprises a water vapor chamber 312 with at least one wall 310. The water vapor chamber 312 may be substantially similar to the water vapor chamber described above with regards to FIG. 1. In one embodiment, the water vapor chamber 312 is substantially serpentine, such that the wall 310 supports the water-selective membrane and the serpentine curves in the wall 310 provide turbulence in the water vapor flow. The turbulence provides more consistent humidification. The at least one wall 310 may comprise a single curved wall, or multiple walls in a rectangular, triangular, or other multiple-wall chamber configuration. In one embodiment, the water vapor chamber 312 also comprises a support member 316 disposed within the water vapor chamber 312 to support the water-selective membrane such that the water vapor chamber 312 remains passable to the water vapor flow. The support member 316 may comprise pillars, posts, internal walls, ribs, or other structures within the water vapor chamber, and may be in a predefined pattern. The support member 316 may further provide turbulence to the water vapor flow.

The water vapor chamber 312 may also comprise one or more outlet passages 314 connecting the water vapor chamber 312 to the water vapor outlet 308. The one or more outlet passages 316 provide fluid communication between the water vapor chamber 312 and the water vapor outlet 308. In one embodiment, the outlet passages 314 are cross-drill ported during manufacturing.

The water vapor chamber 312 may also comprise one or more inlet passages 318 connecting the water vapor chamber 312 to a water vapor inlet 324. The one or more inlet passages 318 provide fluid communication between the water vapor chamber 312 and the water vapor inlet 324. In one embodiment, the inlet passages 319 are cross-drill ported during manufacturing. In one embodiment the water vapor inlet 324 receives the water vapor flow from a water vapor outlet of the fuel cell stack. In a further embodiment, the water vapor inlet 324 may receive the water vapor flow from another water vapor source, or may receive a flow that is substantially liquid water from a water pump, reservoir, or other water source.

In one embodiment, the top humidifier body 300 comprises one or more fuel cell stack assembly fasteners 320. The one or more fuel cell stack assembly fasteners 320 may be substantially similar to the fasteners 122 described above with regards to FIG. 1. The fuel cell stack assembly fasteners 320 secure the top humidifier body 300 to a fuel cell stack assembly and integrate the top humidifier body 300 with the fuel cell stack.

In one embodiment, the top humidifier body 300 comprises a fuel cell hydrogen outlet passage 322. The fuel cell hydrogen outlet passage 322 is substantially similar to the hydrogen outlet passage 222 of FIG. 2.

FIG. 4 illustrates one embodiment of a base manifold 400. In one embodiment, the base manifold 400 is substantially similar to the input structural layer 118 of FIG. 1, comprising a fuel cell stack input manifold 400 that provides inputs for the oxygen flow and the hydrogen flow from an oxygen source and a hydrogen source, and guides the input gas flows to an input gas humidifier. Alternatively, the base manifold 400 guides a hydrogen flow to the input gas humidifier. It should be noted that in embodiments that pass both the hydrogen flow and the oxygen (or air) flow through the same integrated humidifier 110, the two or more multiple input gas chambers keep the hydrogen flow and the oxygen (or air) flow from mixing. The water vapor chamber on the other side of the water-selective membrane 116 may have multiple water vapor chambers in certain embodiments and may have a single water vapor chamber in other embodiments.

The base manifold 400 may comprise integrated manifolds, tubing, or other passages to guide the input gas flows. The base manifold 400 may comprise a polymer, a metal, or another material capable of housing manifolds, passages, inlets, and outlets, and of supporting an input gas humidification system.

In one embodiment, the base manifold 400 comprises a hydrogen inlet 402 that is in fluid communication with a hydrogen outlet 408. The hydrogen inlet 402 may receive a hydrogen flow from a hydrogen generation system, a hydrogen pump, a pressurized hydrogen storage system, or from another hydrogen source. The hydrogen outlet 408 may be in fluid communication with either a hydrogen humidifier or a fuel cell stack, bypassing an air humidifier as described above with regards to FIG. 2 and FIG. 3.

In one embodiment, the base manifold 400 comprises a water vapor outlet 404 that is in fluid communication with a water vapor inlet 410. The water vapor outlet 404 receives an excess water vapor flow through the water vapor inlet 410 from an input gas humidifier. The water vapor outlet 404 may send the excess water vapor flow to a vent, a condenser, or elsewhere.

In one embodiment, the base manifold 400 comprises a hydrogen outlet 406 that is in fluid communication with a hydrogen inlet 426. The hydrogen outlet 406 receives a purged hydrogen flow from a fuel cell stack through the hydrogen inlet 426, and sends the purged hydrogen flow to hydrogen storage, a vent, a condenser, or elsewhere.

In one embodiment, the base manifold 400 comprises one or more plugs 412, 422, 424, 426, 430. The plugs 412, 422, 424, 426, 430 seal excess holes in the base manifold 400. The excess holes may be a byproduct of a manufacturing process such as cross-drill porting of passages within the base manifold 400.

In one embodiment, the base manifold 400 comprises an input gas filter port 414. The input gas filter port 414 may interface with an input gas filter such as an air or oxygen filter, or a hydrogen filter. The input gas filter port 414 may be in fluid communication with one or more pump inputs 416. One or more input gas pumps, such as air or oxygen pumps, or hydrogen pumps, may pump an input gas flow through an input gas filter and into the input gas filter port 414, from the input gas filter port 414 to the pump inputs 416, through the pumps, and out one or more pump outputs 418. The pump outputs 418 may be in fluid communication with an input gas outlet 420. The input gas outlet 420 may be in fluid communication with an input gas inlet of a humidifier, as described above.

In one embodiment, the base manifold 400 comprises one or more fasteners 432. The fasteners 432 may be substantially similar to the fasteners 122 of FIG. 1. The fasteners 432 secure a fuel cell stack assembly to the base manifold 400. The inlets and outlets 402, 404, 406, 408, 410, 414, 416, 418, 420, 426 may also comprise one or more sealing means such as O-rings, gaskets, caulk, or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for humidifying input gas for a proton exchange membrane fuel cell stack, the apparatus comprising:
an input gas chamber integrated with a fuel cell stack, the input gas chamber comprising at least one wall, the input gas chamber having an input gas inlet that receives an input gas flow and an input gas outlet in fluid communication with the fuel cell stack;
a water vapor chamber integrated with the fuel cell stack, the water vapor chamber comprising at least one wall, the water vapor chamber having a water vapor inlet and a water vapor outlet, the water vapor inlet receiving a water vapor flow from the fuel cell stack; and
a water-selective membrane disposed between the input gas chamber and the water vapor chamber, the water-selective membrane forming a common wall between the input gas chamber and the water vapor chamber, the water-selective membrane configured to selectively diffuse water from the water vapor flow to the input gas flow.

2. The apparatus of claim 1, wherein the input gas chamber and the water vapor chamber are formed within one or more structural layers of the fuel cell stack, the structural layers having an area footprint less than or equal to an area footprint of at least one fuel cell in the fuel cell stack.

3. The apparatus of claim 2, wherein the input gas chamber is formed within a first structural layer of the fuel cell stack and the water vapor chamber is formed within a second structural layer of the fuel cell stack.

4. The apparatus of claim 3, wherein the first structural layer is a fuel cell stack input manifold and the second structural layer is formed within a fuel cell stack plate, the fuel cell stack input manifold and fuel cell stack plate positioned to receive an input gas entering the fuel cell stack.

5. The apparatus of claim 3, further comprising an O-ring disposed between the first structural layer and the second structural layer, the O-ring substantially circumscribing the input gas chamber and the water vapor chamber, the O-ring providing a seal between the first structural layer and the second structural layer.

6. The apparatus of claim 2, wherein the one or more structural layers are coupled to the fuel cell stack by way of at least one fuel cell stack fastener that joins two or more fuel cells by way of compression, the structural layers having one of a length and a width that is less than or equal to a corresponding length and width of one of the fuel cells in the fuel cell stack.

7. The apparatus of claim 1, further comprising an input gas path to the input gas chamber, the input gas path to the input gas chamber and a cross-sectional area of the input gas chamber configured to minimize a pressure drop between the input gas inlet and the input gas chamber.

8. The apparatus of claim 1, wherein the input gas flow comprises oxygen gas.

9. The apparatus of claim 8, wherein the input gas is ambient air.

10. The apparatus of claim 8, further comprising a hydrogen chamber integrated with the fuel cell stack, the hydrogen chamber comprising at least one wall, the hydrogen chamber having an input gas inlet that receives a hydrogen flow and an input gas outlet in fluid communication with the fuel cell stack, the hydrogen chamber disposed on an opposite side of the water-selective membrane as the water vapor chamber.

11. The apparatus of claim 1, wherein the input gas flow comprises hydrogen gas.

12. The apparatus of claim 1, wherein a rate of diffusion of water through the water-selective membrane is determined by a water concentration gradient across the water-selective membrane.

13. The apparatus of claim 1, wherein the water-selective membrane is substantially impermeable to hydrogen, nitrogen, oxygen, and metallic oxides.

14. The apparatus of claim 1, further comprising a first support member disposed within the water vapor chamber, the first support member configured to support the water-selective membrane such that the water vapor chamber remains passable to the water vapor flow.

15. The apparatus of claim 14, wherein the input gas chamber and the water vapor chamber have substantially serpentine shapes, and the first support member comprises a wall of the water vapor chamber.

16. The apparatus of claim 14, wherein the first support member comprises a rib disposed in a substantially central position between two opposite sides of the water vapor chamber.

17. The apparatus of claim 14, wherein the first support member and one or more additional support members are disposed within the water vapor chamber according to a pattern, the pattern configured to generate turbulence in the water vapor flow.

18. The apparatus of claim 1, wherein the input gas chamber and the water vapor chamber are oriented such that liquid water from the water vapor flow collects on the water-selective membrane, in response to gravity.

19. A system for humidifying input gas for a proton exchange membrane fuel cell stack, the system comprising:
a fuel cell stack comprising a fuel cell stack air inlet, a fuel cell stack water vapor outlet, and one or more hydrogen fuel cells in a stack configuration, the hydrogen fuel cells configured to generate electric power using hydrogen and oxygen;
one or more air pumps configured to provide the air flow to a humidifier air inlet;
an air humidifier having an area footprint less than or equal to an area footprint of at least one fuel cell in the fuel cell stack, the air humidifier comprising:
an air chamber formed within an air chamber body, the air chamber configured to guide the air flow from the humidifier air inlet to a humidifier air outlet, the humidifier air outlet in fluid communication with the fuel cell stack air inlet;
a water vapor chamber formed within a water vapor chamber body, the water vapor chamber configured to guide a water vapor flow from a humidifier water vapor inlet to a humidifier water vapor outlet, the humidifier water vapor inlet in fluid communication with the fuel cell stack water vapor outlet; and
a water-selective membrane disposed between the air chamber and the water vapor chamber, the membrane forming a common wall between the oxygen chamber and the water vapor chamber, the water-selective membrane configured to selectively diffuse water from the water vapor flow to the air flow.

20. The system of claim 19, further comprising an air intake filter configured to filter particles from the air flow;

21. The system of claim 20, further comprising a base manifold having one or more air passages, the air passages providing fluid communication between the air intake filter, the one or more air pumps, and the air humidifier, the base manifold further providing structural support for the air intake filter, the one or more air pumps, and the fuel cell stack.

22. An apparatus for humidifying input gas for a proton exchange membrane fuel cell stack, the apparatus comprising:
a serpentine oxygen chamber formed within a first structural layer of a fuel cell stack, the serpentine oxygen chamber configured to guide an oxygen flow from an oxygen inlet to an oxygen outlet, the oxygen outlet in fluid communication with the fuel cell stack;
a serpentine water vapor chamber formed within a second structural layer of the fuel cell stack, the serpentine water vapor chamber configured to guide a water vapor flow from a water vapor inlet to a water vapor outlet; and
a water-selective membrane disposed between the serpentine oxygen chamber and the serpentine water vapor chamber, the membrane forming a common wall between the serpentine oxygen chamber and the serpentine water vapor chamber, the water-selective membrane configured to selectively diffuse water from the water vapor flow to the oxygen flow.

23. The apparatus of claim 22, wherein the first structural layer and the second structural layer are coupled to the fuel cell stack by way of at least one fuel cell stack fastener that joins two or more fuel cells by way of compression, the first and second structural layers having one of a length and a width that is less than or equal to a corresponding length and width of one of the fuel cells in the fuel cell stack.
